(19) United States
(12) Patent Application Publication
(10) Pub. No.: US 2024/0041072 A1
(43) Pub. Date: Feb. 8, 2024

(54) Non-alcoholic functional beverage with a malt base or based on non-alcoholic beer or a water-aroma base enriched with amino acids and dietary fibre as well as a method of manufacturing a non-alcoholic functional beverage with a malt base or based on non-alcoholic beer or a water-aroma base, enriched with amino acids and dietary fibre

(71) Applicant: DRINK ID Spolka z Oganiczona Odpowiedzialoscia, Piotrków Trybunalski (PL)

(72) Inventors: Joanna BERLOWSKA, LODZ (PL); Dorota KREGIEL, LODZ (PL); Hubert ANTOLAK, LODZ (PL); Monika SZYMANSKA, Smardzewice (PL)

(21) Appl. No.: 18/382,034

(22) Filed: Oct. 19, 2023

Related U.S. Application Data
(63) Continuation of application No. 17/121,725, filed on Dec. 14, 2020, now abandoned.

(30) Foreign Application Priority Data
Jun. 12, 2018 (PL) P.425903

(51) Int. Cl. A23L 2/66; A23L 33/145; A23L 33/22; A23L 33/175; A23L 33/105; A23L 2/46; A23L 2/72

(52) U.S. Cl. CPC A23L 2/66; A23L 33/145; A23L 33/22; A23L 33/175; A23L 33/105; A23L 2/46; A23L 2/72; A23V 2002/00

(57) ABSTRACT

A non-alcoholic functional beverage based on non-alcoholic beer enriched with amino acids and dietary fibre containing:
5.6%-10% v/v of yeast autolysate obtained from waste yeast slurry containing all free protein amino acids, both exogenous and endogenous, as well as three non-protein amino acids, i.e. taurine, ornithine and gamma aminobutyric acid, wherein the total content of free amino acids ranges from 30 to 49 g/l of autolysate and wherein the pH of the autolysate ranges from 4.7 to 5.9;
10%-20% v/v of a suspension of dietary fiber derived from crushed brewers spent grain, wherein this suspension is a mixture of soluble and insoluble dietary fiber fractions containing particles of the size up to 0.5 mm;
70% to 84.4% of non-alcoholic bee.

The present invention relates to a non-alcoholic functional beverage with a malt base or based on non-alcoholic beer or a water-aroma base, enriched with amino acids, and dietary fibre and a method of manufacturing a non-alcoholic functional beverage with a malt base or based on non-alcoholic beer or a water-aroma base, enriched with amino acids and dietary fibre for application as a nutraceutical for each age group.

Dietary fibre as well as essential amino acids are very important for the correct functioning of the organism.

Dietary fibre has a lot of health-promoting properties, which include:
a positive effect on carbohydrate metabolism by decreasing plasma glucose concentrations;
enhancing the feeling of satiation after a meal as a result of filling of the stomach;
improving lipid metabolism by decreasing concentrations of total cholesterol and triglycerides;
swollen dietary fibre moves from the stomach to the intestines where it stimulates intestinal peristalsis and the process of digestion;
a natural detox effect. While swelling in the alimentary tract it binds many toxins and harmful products of metabolism and intestinal fermentation.

At is has been disclosed in various publications, insoluble and soluble fibre have different properties. For example insoluble fibre can help promote bowel health and regularity. It also supports insulin sensitivity.

As soluble fibre dissolves, it creates a gel that may improve digestion in a number of ways. Soluble fibre has also other properties, for example it may reduce blood cholesterol and sugar. It helps body improve blood glucose control.

Amino acids are essential for the correct functioning of the organism. They can be divided into essential (exogenous) amino acids, which cannot be synthesised by the human organism and thus must be supplied in adequate amounts in the diet (leucine, isoleucine, valine, lysine, threonine, methionine, phenylalanine and tryptophan) and conditionally essential amino acids, which are not synthesised in adequate amounts in infants or in ill individuals and must be supplied to them in the diet (histidine and arginine). They take part in synthesising substances that are important for the health, such as hormones (e.g. insulin, thyroxine, and adrenaline), bodily fluids, enzymes and neurotransmitters transmitting electrical impulses in the brain. Amino acids also assist in regeneration of damaged cells, muscles, skin and internal organs. During intense physical activity amino acids turn into building material for muscles and a source of energy, therefore they are taken by people doing sports. Due to these properties, amino acids are used in treating people suffering from loss of muscle mass (e.g. in the elderly, bedridden and otherwise immobilised patients). Deficiency of amino acids is typically caused by improper diet, e.g. eating low-protein meals or vegetarian diet but it can also be caused by a disease. Lack of amino acids, e.g. cysteine, is manifested by compromised immunity and impaired fat burning. The deficiency can be replenished with appropriate food products or preparations.

In the state of the art, there are known various kinds of functional beverages. They contain dietary fibre or essential amino acids. However, any functional beverages containing both these ingredients are not known.

At the same time, it is also a huge technological challenge to create a functional beverage that would make it possible to utilise to the largest possible extent the waste materials produced by the brewing industry.

It is important to utilise yeast slurry containing approx. 10% of dry mass of Saccharomyces cerevisiae yeast, which lost its vitality and viability in the course of the production of alcohol from malt sugars in the production of beer, where it is also crucial that autolysates be obtained without added salt or ethyl alcohol so as not to introduce any foreign flavours and not to disturb the character of the ready beverage, and also to make it suitable for all age groups. In this case “approximately, approx.” should be understood as that the post-fermentation yeast slurry (Saccharomyces cerevisiae) makes from 7 to 10% of dry mass in the liquid at the beginning of the process of lysis.

Autolysates of yeast cells are a precious source of proteins and yeast extracts are more and more commonly used in the food industry as flavour enhancers, with the aroma or flavour of cheese, broth or meat, and as dietary supplements. These preparations are used as aroma enhancers in foodstuffs such as sauces, soups, and meat and fish dishes as well as in seasoning mixtures. Yeast extracts are obtained, inter alia, from food yeast and also post-fermentation yeast used in the production of beer or wine.

In the state of the art, there are known various methods of obtaining essential amino acids. Inter alia, in patent PL226057 there is described a method of obtaining yeast cell extract intended for food or feed uses.

The method of obtaining extracts from yeast cell by way of simultaneous inactivation and induced autolysis of yeast cells, as described in patent PL226057 and the embodiments, consists in heating a yeast cell suspension at below 100° C. with added autolysis inducer, for up to 48 hours, and then separating the autolysate from the rest by way of centrifuging or filtration and fixing it with optional use of NaCl, alcohol, proteolytic enzymes as autolysis inducers, in which the autolysis inducer used is saponin obtained from the soap bark tree, Quillaja saponaria, pure or in the form of soap bark extract, in the amount of 0.001-1% by weight relative to the yeast cell mass, or with another inducer or other inducers of autolysis like NaCl used in the amount of 10-50% by weight relative to the yeast cell mass and/or alcohol used in the amount of 10-70% by weight relative to the yeast cell mass and/or exo- or endoproteases used in such amount that ensures activity of 1-100 U/ml yeast suspension. The process of inactivation and autolysis is applied to a yeast cell suspension with a density of 105-1010 cfu/mL, which is heated with an autolysis inducer or autolysis inducers for 12-48 hours at 30-60° C.

Research is also focussed on finding fast and low-cost ways of obtaining dietary fibre from brewers' grains and using it in functional beverages.

Brewers' grains are a perishable product and must be used within a short time or preserved by ensiling or drying. There are studies concerning hydrolysis of brewers' grains by means of acids, bases or enzymes in order to obtain hydrolysates with a high content of simple sugars which are subsequently used mainly in fermentation processes to produce ethanol or lactic acid. A significant content of celluloses, hemicelluloses and especially lignins, forming a compact structure, in brewers' grains hinders enzymatic decomposition of grains and thereby constitutes an obstacle to effective utilisation of saccharides. It is believed that the kind of pre-treatment of brewers' grains as well as the manner of conducting the hydrolysis itself with cellulolytic enzymes involved in the process has an impact on the kind and quality of the obtained hydrolysate.

Even if there are many attempts to use waste materials produced by the brewing industry (yeast autolizate or brewers spent grains), there is no method or product enabling direct use of amino acids from yeast autolizate and dietary fiber from brewers spent grain.

One of the patents disclosing the use of yeast from the brewing industry is EP2995204B1 (Liebert et al.). It relates to a method of increasing the quantity of bioavailable vitamin B12 in a cell multiplication process of selected strains of lactic bacteria on a culture medium based on the brewing wort (being the source of carbohydrates for the bacteria) enriched with a nutrient which was yeast extract there.

In EP2995204B1 yeast products were used since lactic acid bacteria are very demanding organisms and for their proper development they need many nutrients in the environment, which in the described invention were supplied precisely from the processed yeast extracts. Brewer's yeast (i.e. their extract) was treated as the source of proteins, mineral salts, vitamins from group B, amino acids ect.—i.e. factors that stimulate the growth of lactic acid bacteria, where the nutrients are further metabolized by lactic acid bacteria. In this invention, the content of B12 in the product increased while yeast (autolysate)/the components of yeast autolysate were consumed (metabolized) by lactic acid bacteria. As defined in the invention, the best was to use fresh cropping yeast, waste yeast were not preferable. In this invention it was important that the wort was poorly hopped because high hopping inhibits the growth of lactic bacteria.

The product further used in food industry contained lactic acid bacteria and increased content of B12, but it did not contain yeast autolysate.

This publication also mentions the use of β-glucan or β-glucan-containing additives, however it cannot be compared to the dietary fiber from natural brewers spent grains.

Another attempts to use the waste materials from brewery are disclosed in the U.S. Pat. No. 5,439,701 B1 (Zimlich et al.) relating to the production of flavoring compositions from the thin stillage portion produced during alcoholic beverage distillation, and from the yeast-containing portion of a by-product of beer production. The aim of the invention disclosed in U.S. Pat. No. 5,439,701B1 was to obtain additives that are flavoring agents for other food and feed applications. The flavoring composition pH was modified to the range from 7 to 11 or 10.5 which required treatment of the yeast autolysate with various alkalizing agents, i.e. potassium, calcium bases, etc.). Also the flavoring composition was subjected to thermal treatment at different temperatures and at different times. According to the inventor, depending on different pH conditions, temperature and time, different taste effects could be obtained, e.g. caramel, nutty. The composition was also finally dried and in this form added to other food.

In addition U.S. Pat. No. 5,439,701B1 discloses also use of brewers spent grains as/in a flavoring composition. According to the invention, brewers grains were subjected for example to drying either prior to be used in the composition or further, since the composition was finally dried. Drying may influence the composition/properties of brewers spent grains, and thus the brewers spend grains used are not “natural”.

The fact that “intermediate steps” are performed (use of modifiers to obtain desired changes in pH values between 7 and 11 or drying of particular components of the flavouring composition), results in modification of molecular properties of the waste yeast and brewers grains (which was reflected in flavor change). Depending also on the “intermediate steps”, the change in final composition of the product in which the flavoring composition would be used would be observed.

However, the focus of U.S. Pat. No. 5,439,701B1 was to obtain additives that are flavoring agents for other food and feed applications of particular taste, and not to maintain best health promoting properties of yeast autolysate and brewers spent grains. The aim of the invention disclosed in was not to obtain fiber or free amino acids, thus they are not even mentioned.

None of these patents or publications, however discloses or suggests a method of preparing a non-alcoholic functional beverage enriched with amino acids and dietary fibre as well as a method of manufacturing a non-alcoholic functional beverage with natural amino acids and natural dietary fibre obtained from the by-product of beer production process. Also none of these publications suggests a non-alcoholic functional beverage containing dietary fiber from brewers spent grains and amino acids from the yeast autolysate or natural dietary fiber from brewers spent grains or amino acid from the yeast autolysate.

The aim of the invention is to develop a functional beverage from the group of so-called nutraceutical containing natural dietary fibre obtained from fragmented brewers' grains and amino acids obtained from waste yeast slurry and thereby to combine in a functional beverage amino acids (essential and conditionally essential free amino acids) and dietary fibre which are nutritionally valuable and health-promoting, and moreover, their properties are complementary with each other.

The purpose of the solution according to the invention is also to develop a fast and cost-effective method of obtaining amino acids from yeast autolysate and dietary fibre from brewers' grains for further use in a beverage.

The aim of the invention is also to create a functional beverage maintaining the properties and composition of yeast autolyzate and dietary fiber from brewers spent grains.

A non-alcoholic functional beverage according to the invention is characterised in that it contains:
5.6-10% v/v of yeast autolysate obtained from waste yeast slurry containing all free protein amino acids, both exogenous and endogenous, as well as three non-protein amino acids, i.e. taurine, ornithine and gamma aminobutyric acid, wherein the total content of free amino acids ranges from 30 to 49 g/l of autolysate and wherein the pH of the autolysate ranges from 4.7 to 5.9;
10%-20% v/v of a suspension of dietary fiber derived from fragmented brewers spent grain, wherein this suspension is a mixture of soluble and insoluble dietary fiber fractions containing particles of the size up to 0.5 mm,
70%-84.4% of non-alcoholic beer,
wherein the non-alcoholic beer is a product resulting from bottom fermentation of malt wort, wherein the beer contains no more than 0.5% ethanol by volume and has a pH in the range of 4.2 to 4.5 and a bitterness in the range of 25-35 IBU.
   wherein the content of free amino acids in the non-alcoholic functional beverage ranges from 1.68-4.9 g/l of the finished product.

The lysate is obtained in the autolysis process of post-fermentation brewing yeast. The dose of lysate is selected to obtain the desired content of free amino acids in the finished product. The dose is also selected taking into account the beneficial properties and the sensory aspects of the finished product; which should remain neutral and not add any umami flavor.

An autolysate obtained from waste yeast slurry is mostly liquid nutrient substrate obtained preferably without added salt or ethyl alcohol in the process of this invention which is beneficial for the product.

Yeast autolysate for the purpose of this invention may preferably be obtained in such manner that yeast slurry is subjected to the process of incubation conducted in a reactor with a heating mantle (45-50° C.) and mixing with water in the ratio of 1:1 with added saponin (Quillaja extract) as the inducer where the saponin concentration is 0.04% w/v relative to diluted yeast slurry; then, after completing the stage of autolysis, the solid fraction is separated by centrifuging in a cooled centrifuge and the liquid fraction containing amino acids may be used for drink.

Particles larger than 0.5 mm are hard fragments of spent grain that were not crushed during homogenization. They have been filtered out so that they do not interfere with the sensory reception of the product. The dietary fiber suspension has not been subjected to any thermal treatment, such as drying, in order not to change the natural proportions of soluble and insoluble fiber fractions.

Preferably according to the invention, the pH of the non-alcoholic beverage ranges from 4.2 to 4.7.

Preferably according to the invention the yeast autolysate is from post-fermentation yeast of the genus Saccharomyces.

Preferably according to the invention, the yeast autolysate contains from 30 to 31 g/l of free amino acids.

Preferably according to the invention the non-alcoholic functional beverage comprises 3 g/l of free amino acids.

Preferably according to the invention the non-alcoholic functional beverage is characterized in that the content of dietary fiber in the suspension of dietary fiber ranges from 20% to 30% of dry mass, and even more preferably, the content of dietary fiber in the suspension of dietary fiber ranges from 21% to 25% of dry mass.

Preferably according to the invention the non-alcoholic functional beverage is characterized in that the content of dietary fiber in the suspension of dietary fiber ranges from 24.5% to 25% of dry mass.

Preferably according to the invention, the content of the insoluble fraction of dietary fiber in the suspension of dietary fiber ranges from 20%-27.5% DM (dry mass) and the soluble fraction of dietary fiber in the suspension of dietary fiber ranges from 2.5% to 5% DM.

Preferably according to the invention the non-alcoholic functional beverage is characterized by that the insoluble fraction of dietary fiber content in the suspension of dietary fiber is 21% DM (dry mass), and the soluble fraction of dietary fiber content in the suspension of dietary fiber is 3.5% DM.

Preferably according to the invention the dietary fiber content per liter of finished product (functional beverage) is 15 g/l.

Most preferably the non-alcoholic functional beverage comprises:
6.4% v/v of yeast autolysate wherein the content of free amino acids is 47 g/l of yeast autolysate,
10% v/v of dietary fiber suspension containing 250 g of dietary fiber per 1 liter of dietary fiber suspension,
83.6 v/v of non-alcoholic beer,
   wherein the non-alcoholic functional beverage contains 3g/l of free amino acids and 25 g/l of dietary fiber.

Bottom fermentation of malt wort is fermentation that took place using bottom fermenting yeast, i.e. yeast that sinks to the bottom of the fermentation tank after the fermentation process. Top-fermenting yeast remains on the surface of the fermented liquid after the fermentation process and, among other things, it differs from bottom-fermenting yeast. For example all pilsners and lagers are made using bottom-fermenting yeast. Preferably the yeast for the lysate is bottom fermenting yeast.

Beers made using top-fermenting yeast differ in terms of sensory and physicochemical characteristics from beers made using bottom-fermenting yeast. Bottom-fermented beers have lower contents of fruity esters, which create a flavor associated with bananas, cloves or fruit esters. After maturation, bottom-fermented beers have lower contents of diketones associated with the taste of toffee or cream.

In addition, bottom-fermented beers have a different acid balance. Generally, bottom-fermented beers have a pH higher than 4.2, which is not so obvious in the case of top-fermented beers.

Top-fermented beers may have a higher alcohol content. Top-fermenting yeast is slightly less sensitive to high ethanol concentrations.

When dietary fiber obtained directly from spent grain is used, without additional chemical treatment it remains natural. They are used directly in a liquid form which first of all maintains natural properties of the fiber (for example insoluble vs. soluble fibre content). Changes of the proportions of the soluble vs. insoluble dietary fiber, also changes the properties of the beverage.

When amino acids coming directly from yeast are used they are natural and maintain all their properties.

In this case, the natural compound comes directly from the spent grain, without side effects and flowing directly from the yeast. They are obtained through the action of natural enzymes.

The non-alcoholic functional beverage with a malt base or based on non-alcoholic beer or a water-aroma base, enriched with amino acids, and dietary fibre according to the invention is characterised in that it contains both autolysate obtained from waste yeast slurry and dietary fibre obtained from fragmented brewers' grains.

The method of manufacturing a non-alcoholic functional beverage with a malt base or based on non-alcoholic beer or a water-aroma base, enriched with amino acids and dietary fibre is characterised in that dietary fibre suspension and yeast autolysate are obtained in separate (parallel) technological processes where the dietary fibre suspension is obtained in such manner that brewers' grains are mixed with water in the ratio of 1:1, then fragmented at room temperature in a homogeniser, and then the obtained suspension is filtered through a filtration fabric in order to separate particles larger than 0.5 mm while yeast autolysate is obtained in such manner that yeast slurry is subjected to the process of incubation conducted in a reactor with a heating mantle (45-50° C.) and mixing with water in the ratio of 1:1 with added saponin (Quillaja extract) as the inducer where the saponin concentration is 0.04% w/v relative to diluted yeast slurry; then, after completing the stage of autolysis, the solid fraction is separated by centrifuging in a cooled centrifuge, after which the dietary fibre suspension and/or autolysate is/are combined with the base ingredients in the form of malt base or non-alcoholic beer or water-aroma base enriched with flavour and aroma additives to create a non-alcoholic functional beverage.

The advantageously obtained dietary fibre suspension and autolysate are in the first instance stored under refrigeration for up to 48 hours and afterwards they undergo pasteurisation, and then they are combined with the base ingredients in the form of malt base or non-alcoholic beer or water-aroma base enriched with flavour and aroma additives to create a non-alcoholic functional beverage.

It is also advantageous when the obtained dietary fibre suspension and autolysate are in the first instance combined with the base ingredients in the form of malt base or non-alcoholic beer or water-aroma base enriched with flavour and aroma additives to create a non-alcoholic functional beverage which is subsequently subjected to pasteurisation.

Based on the research carried out, it appears that the process of obtaining amino acids from waste yeast slurry allows for a reduction of the waste produced on average by 50%.

The functional beverage that the present invention refers to is characterised by a low sugar content, low caloric content and a pleasant, refreshing taste. The beverage is enriched with soluble dietary fibre the source of which are fragmented, diluted (1:1) brewers' grains in which the soluble fraction of dietary fibre makes up approx. 3.5% DM (approx. means from 2.5% to 5% DM) while the insoluble fraction makes up approx. 21% DM (approx. means from 20% to 27.5% DM) and with amino acids obtained from a natural source (waste yeast slurry). The amino acid pool obtained from waste yeast slurry is characterised by the presence of essential and non-essential amino acids, including branched-chain amino acids (BCAA), i.e. leucine, isoleucine and valine. The source of amino acids is yeast autolysate, containing acc. to preliminary assumptions a total of approx. 31 mg of amino acids per mL, of which essential and conditionally-essential amino acids will be 17.9 mg/mL.

Obtaining clear autolysate is possible using a cooled centrifuge (approx. 10° C., 3,000×g). The greater the centrifugal force (g-force), the better separation of remaining waste yeast slurry.

The most advantageous amino acid profiles of autolysates (the lowest protein level and the highest FAN (Free Amino Nitrogen) level) were obtained in the process of incubation after 48 hours, where the inducer was saponin (Quillaja extract) in a concentration of 0.08% w/v (for undiluted yeast slurry, i.e. 0.04% w/v for waste yeast slurry diluted 1:1) at 45° C. It is estimated that 1 kg of waste yeast slurry mixed with 1 litre of water (weight ratio 1:1) is enough to obtain approx. 1-1.4 litre (L) clear autolysate, after autolysis and separation of the solids. In the autolysis, the total amount of amino acids in the range between 48 g/L and 52.4 g/L of which essential amino acids make up between 50% and 52% depending on the concentration of saponin as the inducer.

Autolysate in this form and at this stage does not contain any preservatives; thus, being a perishable product, it must be stored under refrigeration not longer than 48 hours. If longer storage is required, autolysate must be stored frozen.

The most advantageous method of preservation of brewers' grains intended for supplementing functional beverages is by freezing. This method ensures the microbiological stability of the brewers' grains and the soluble fraction of dietary fibre under storage conditions. If necessary, brewers' grains can also be stored under refrigeration for a maximum of 2 days.

The most advantageous method of preservation of intended for supplementing functional beverages is by freezing. This method ensures above all the microbiological stability of the autolysate under storage conditions as well as maintaining its chemical characteristics. In the studies, freezing was done at −20° C. but freezing at other temperatures, e.g. −5° C., which is typically reached in industrial chest freezers, also preserves both the microbiological and the chemical stability of the autolysate. If necessary, autolysate can be stored under refrigeration for a period not longer than two days (however, such a storage scheme will not provide microbiological protection of autolysate).

The advantage of the solution according to the invention is obtaining a functional beverage with a very high content of essential and conditionally essential amino acids and dietary fibre.

Furthermore, as a result of applying the methods of obtaining amino acids and dietary fibre described herein, waste materials from the brewing industry are utilised. This concerns in particular waste yeast slurry, containing approx. 10% of dry mass of yeast of the Saccharomyces cerevisiae strain, which lost its vitality and viability in the course of the production of alcohol from malt sugars in the production of beer.

In this case “approximately, approx.” should be understood as that the post-fermentation yeast slurry (Saccharomyces cerevisiae) makes from 7 to 10% of dry mass in the liquid at the beginning of the process of lysis.

Also other yeast of the genus Saccharomyces can be used as above.

The utilisation of yeast extract for the production of the functional beverage solves the problem of disposal of waste yeast slurry which is a significant environmental burden because waste yeast slurry is aggressive waste, and its basic form it cannot be processed at the standard biological and chemical treatment plants due to the fact that huge amount of oxygen is required for the degradation of this waste.

In the present invention an autolysate obtained from waste yeast slurry is used. This autolysate in the beverage is the source of amino acids, but it can also contain other substances for example hop bitter substances (resulting from the beer production process). These substances are well acceptable and have no negative effect on the final beverage according to the present invention.

There are known methods of processing waste yeast slurry in order to recover dried yeast and ethyl alcohol. Recovered dried yeast can be used as an additive for animal feed and recovered ethyl alcohol can be used as a contribution to renewable fuels. However, the process wastewater is also noxious waste with a high requirement for oxygen, both biological and chemical.

Hence utilisation of the biomass of waste yeast slurry is of great importance in the context of reducing the biologic and chemical requirement for oxygen in the process of its disposal.

The method of preparing the non-alcoholic beverage according to the invention is presented in embodiments.

### EMBODIMENT 1

Dietary fibre suspension and yeast autolysate are obtained in separate (parallel) technological processes, where:
the dietary fibre suspension is obtained in such manner that brewers' grains are mixed with water in the ratio of 1:1, then the obtained suspension is fragmented in a homogeniser at room temperature and then filtered through a filtration fabric in order to separate particles larger than 0.5 mm;
the yeast autolysate, being a source of essential and non-essential amino acids, is obtained in such manner that waste yeast slurry is subjected to the process of incubation conducted in a reactor with a heating mantle (45-50° C.) and mixing with water in the ratio of 1:1 with added saponin (Quillaja extract) as the inducer where the saponin concentration is 0.04% w/v relative to diluted yeast slurry; then, after completing the stage of autolysis, the solid fraction is separated by centrifuging in a cooled centrifuge.

The dietary fibre suspension and autolysate obtained in this way are stored under refrigeration for up to 48 hours or subjected separately to pasteurisation, which enables preventing intensive Maillard reactions resulting in reduced sugar and FAN content.

An alternative solution consists in adding only pasteurised dietary fibre from brewers' grains, under aseptic conditions, to mechanically sterilised (microfiltration) beverage base with autolysate.

After the process of pasteurisation, the dietary fibre suspension and the autolysate are combined with the base ingredients in the form of malt base or non-alcoholic beer or water-aroma base, enriched with flavour and aroma additives to create a non-alcoholic functional beverage.

In the beverage obtained acc. to the embodiment, autolysate content is 5.6% w/v and the content of dietary fibre from fragmented brewers' grains is at least 2 g/100 mL.

Furthermore, the functional beverage in the on malt base variant also contains other natural ingredients including malt base at 10% v/v, sugar (glucose) at 6.8% w/v, citrus pectin at 0.003% w/v, citric acid at 0.15% w/v, Quillaja saponaria extract (soap bark extract) at 0.0015% w/v, elderberry blossom syrup at 1-4% v/v; it is also enriched with beer aroma at 0.035% v/v and apple or mint aroma at 0.06% v/v.

On the other hand, the functional beverage in the variant based on non-alcoholic beer additionally contains barley malt, bitter and aromatic hops and lactic acid (as acidity regulator).

Malt, hops and lactic acid as acidity regulators are ingredients of non-alcoholic beer, lactic acid is used to regulate the pH of non-alcoholic beer mainly at the stage of the brewing process.

After bottling the functional beverage is stored under refrigeration

### EMBODIMENT 2

In the second embodiment, the dietary fibre suspension and autolysate obtained acc. to the first embodiment are in the first instance combined with the base ingredients in the form of a non-alcoholic beverage or a malt base or non-alcoholic beer, and thereafter subjected to pasteurisation.

The pasteurisation process takes place in a tunnel pasteuriser at 60° C. for 20 minutes or at 80° C. for 10 minutes, or using a flow pasteuriser at 90-93° C. for 60 seconds.

The pasteurisation process is characterised by effectiveness in maintaining the microbiological stability of the functional beverage provided that the appropriate pH level of the beverage is maintained as well as the CO₂ saturation level and the storage temperature.

The embodiments presented herein should by no means be treated as an exhaustive list limiting the scope of the invention the idea of which has been characterised in the patent claims.

### Definitions

Unless otherwise defined, all technical and scientific terms used herein have the same meaning as commonly understood by one of ordinary skill in the art. Preferred methods and materials are described below, although methods and materials similar or equivalent to those described herein can be used in practise or testing of the present invention. All publications, patent applications, patents and other references mentioned herein are incorporated by reference in their entirety. The materials, methods, and examples disclosed herein are illustrative only and not intended to be limiting.

“Autolysate” refers to a liquid obtained as a result of autolysis (perforation) of cells; the term autolysis means that the process took place with the help of the internal enzymes of the yeast cells.

“Beverage” (drink) refers to a liquid intended for human consumption.

“Non-alcoholic beverage” refers to a beverage containing less than 1.2% alcohol by volume (volume/volume %, abbreviation v/v %).

“Free amino acids” refer to molecules that exist as single molecules and are not bound by peptide bonds or other bonds into larger peptide complexes.

“Functional beverage” refers to a beverage that provides the consumer with a specific nutrient, e.g. protein, fibre, magnesium, etc. or, through its composition, has a specific effect on the consumer's body, e.g. by hydrating it, providing medical or health benefits as well as a reduction in disease risk. Functionality can be attributed only to soft drinks (functional beverages are non-alcoholic). Alcoholic beverages, in accordance with the principles of upbringing in sobriety, cannot be functional beverages.

“bottom fermentation of malt wort” or “bottom fermentation” refers to the fermentation that takes place using bottom fermenting yeast, i.e. yeast that sinks to the bottom of the fermentation tank after the fermentation process. Top-fermenting yeast remains on the surface of the fermented liquid after the fermentation process and, among other things, it distinguishes top-fermenting yeast from bottom-fermenting yeast. All pilsners and lagers are made using bottom-fermenting yeast.

“bitterness” refers to the content of bitter substances in hops. Bitterness is determined in International Bitterness Units, (abbreviated to IBU) established by the European Brewery Convention. IBU units indicate how hoppy/bitter the beer is. 1 IBU corresponds to the content of 1 milligram of iso-alpha acids from hops in 1 liter of beer.

“Brewers grains”—brewing grains, for example malt,

“brewers spent grain” is a byproduct of the brewing industry. It is obtained as a mostly solid residue after wort production in the brewing process.

“Dietary fiber” refers to a plant-derived food that cannot be completely broken down by human digestive enzymes. Dietary fibers are diverse in chemical composition, and can be grouped generally by their solubility, viscosity, and fermentability, which affect how fibers are processed in the body. Dietary fiber has two main components: soluble fiber and insoluble fiber.

In the present invention dietary fiber obtained from fragmented brewers' grains preferably contains:
soluble fiber consisting of: β-glucan, arabinoxylans (consisting of arabinose and xylose molecules), as well as xyloglucans;
insoluble fiber is lignin whose monomers are derivatives of coniferyl, sinapyl and coumaryl alcohols. Insoluble fiber is also made of cellulose and some of the hard-hydrolyzing hemicelluloses—a heterogeneous group of polysaccharides consisting of pentoses and hexoses linked by β-glycosidic bonds and from acids.

“suspension of dietary fiber” refer to mixture of soluble and insoluble dietary fiber in water”

“Dry mass” abbreviation “DM” refers to the mass of a biological sample after the water content has been removed. The determination was made after drying the material at a temperature of approximately 103° C. to 105° C. to constant weight. The result is given in % DM. As an example, 10% DM suggests that the suspension contained 10 g solid and 90 g of water.

“The term “beer” as used herein refers to an alcoholic beverage produced by the brewing and fermentation of starches, which are primarily derived from cereal grains (e.g., malted barley, wheat, corn and rice, or mixtures thereof). The term “beer” also refers to beers prepared with all possible alcohol contents.

“Non-alcoholic beer” refers to a beer (created in the fermentation process) with an alcohol content of no more than 0.5% alcohol by volume.

“Conditionally essential amino acids” refers to amino acids considered exogenous, which are essential in specific conditions of the human body, e.g. during intensive growth. They include arginine, cysteine (cystine), tyrosine, proline, glycine, glutamine.

“Essential amino acids” refers to exogenous amino acids that cannot be synthesized from scratch by the human organism and must therefore come from the diet; they are the basic building block of protein, they include: histidine, isoleucine, leucine, lysine, methionine, phenylalanine, threonine, tryptophan, valine.

“Non-essential amino acids” (dispensable, endogenous) refers to amino acids that can be synthesized in sufficient quantities in the human body and do not have to be supplied from food. They include alanine, aspartic acid, asparagine, glutamic acid, serine, glutamine.

“nutraceutical” refers to products derived from food sources that are purported to provide extra health benefits, in addition to the basic nutritional value found in foods.

“Malt base” refers to a liquid resulting from mashing malt, usually barley, with water. During the mashing process, carbohydrates, proteins, polyphenols and mineral salts are released into the water phase. Then the liquid is filtered out in the filtration process from the grain residue, i.e. spent grains. Further, malt base is subjected to cold protein phenolic stabilization followed by filtration, preferably through a diatomaceous earth filter or for e.g. by centrifugation to eliminate proteins and polyphenols. The malt base obtained in this way is clear because the compounds causing haze are eliminated and thus we receive malt base suitable for beverage according to the invention.

“Water-aroma base” refers to a liquid consisting of water and various food additives approved for product categories in accordance with Regulation 1333 of the European Parliament. Thus, water-aroma base as defined herein refers to all non-alcoholic food liquids other than non-alcoholic beer, malt base and water (because the latter is simply supposed to be clean). Thus, it refers to non-alcoholic food drinks created by dissolving ingredients approved for consumption in water and dosing them in drinks.

“Yeast slurry” refers to post-fermentation excess yeast; that have been collected from the fermentation vessels after the fermentation process has been completed.

“% w/v” refers to “weight in volume”. It indicates that a particular weight of a solid is contained in a total volume of solution, for example 0.1% w/v means 1 gram per liter or % w/v=g of solute in 100 ml of solution”.

“v/v” refers to volume in volume, and volume percentage “% v/v”, i.e. ml of a given substance per 100 ml, for example 10% (v/v) means 10 ml in 100 ml.

1. A non-alcoholic functional beverage containing:
5.6%-10% v/v of yeast autolysate obtained from waste yeast slurry containing all free protein amino acids, both exogenous and endogenous, as well as three non-protein amino acids, i.e. taurine, ornithine and gamma aminobutyric acid, wherein the total content of free amino acids ranges from 30 to 49 g/l of autolysate and wherein the pH of the autolysate ranges from 4.7 to 5.9;
10%-20% v/v of a suspension of dietary fiber derived from fragmented brewers spent grain, wherein this suspension is a mixture of soluble and insoluble dietary fiber fractions containing particles of the size up to 0.5 mm,
70% to 84.4% of non-alcoholic beer,
wherein the non-alcoholic beer is a product resulting from bottom fermentation of malt wort, wherein the beer contains no more than 0.5% ethanol by volume and has a pH in the range of 4.2 to 4.7 and a bitterness in the range of 25-35 IBU,
wherein the content of free amino acids in the non-alcoholic functional beverage ranges from 1.68 to 4.9 g/l of the finished product.

2. The non-alcoholic functional beverage according to claim 1, wherein the pH of the non-alcoholic beverage ranges from 4.2 to 4.7.

3. The non-alcoholic functional beverage according to claim 1, wherein the yeast autolysate is from post-fermentation yeast of the genus Saccharomyces.

4. The non-alcoholic functional beverage according to claim 1, wherein the yeast autolysate contains from 30 to 31 g/l of free amino acids.

5. The non-alcoholic functional beverage according to claim 1, comprising 3 g/l of free amino acids.

6. The non-alcoholic functional beverage according to claim 1, wherein the content of dietary fiber in the suspension of dietary fiber ranges from 20% to 30% of dry mass, preferably from 21% to 25% of dry mass.

7. The non-alcoholic functional beverage according to claim 1, wherein the content of dietary fiber in the suspension of dietary fiber ranges from 24.5% to 25% of dry mass.

8. The non-alcoholic functional beverage according to claim 1, wherein the content of insoluble fraction of dietary fiber in the suspension of dietary fiber ranges from 20% to 27.5% DM (dry mass), and the soluble fraction of dietary fiber in the suspension of dietary fiber ranges from 2.5% to 5% DM.

9. The non-alcoholic functional beverage according to claim 1, wherein the content of insoluble fraction of dietary fiber in the suspension of dietary fiber is 21% DM, and the soluble fraction of dietary fiber in the suspension of dietary fiber is 3.5% DM.

10. The non-alcoholic functional beverage according to claim 1, wherein the dietary fiber content per liter of beverage is 15 g/l.

11. The non-alcoholic functional beverage according to claim 1, comprising:
6.4% v/v of yeast autolysate wherein the content of free amino acids is 47 g per 1 liter of yeast autolysate,
10% v/v of dietary fiber suspension containing 250 g of dietary fiber per 1 liter of dietary fiber suspension
83.6 v/v of non-alcoholic beer,
wherein the non-alcoholic functional beverage contains 3g/l of free amino acids and 25 g/l of dietary fiber.
